(19) United States
(12) Patent Application Publication
(10) Pub. No.: US 2008/0138609 A1
(43) Pub. Date: Jun. 12, 2008

(54) Infrared reflective pigments in unpainted automotive plastics

(75) Inventor: Eric Walker, Dublin, OH (US)

Correspondence Address: PRASS & IRVING, LLP, 2661 RIVA ROAD, BUILDING 1000, SUITE 1044, ANNAPOLIS, MD, 21401, US

(73) Assignee: Honda Motor Co., Ltd., Tokyo (JP)

(21) Appl. No.: 11/601,779

(22) Filed: Nov. 20, 2006

(51) Int. Cl. B32B 9/04; H05B 6/00; C09D 5/33

(52) U.S. Cl. 428/333; 427/595; 523/135

(57) ABSTRACT

This disclosure is directed to a plastic composition for use on an automotive vehicle including an infrared reflective pigment, and a thermoplastic component. The plastic composition with the infrared reflective component therein increases reflectance by at least about 300% in the spectrum between about 750 nm and about 2500 nm wavelength over a color matched plastic composition containing no infrared reflective pigment, and provides a delta T of at least about 15 C. over a color matched plastic composition containing no infrared reflective pigment under the procedures set forth in the ASTM Standard D 4803-97 test method. The plastic composition also provides a method of reducing the heat build-up of a plastic automotive vehicle part when the plastic automotive vehicle part is exposed to an infrared radiation source.

### BACKGROUND

1. Field of the Invention

The present teachings relate to plastic compositions composed of infrared (“IR”) reflective pigments dispersed in unpainted automotive plastics.

2. Discussion of the Related Art

Plastic automotive parts, especially exterior automotive parts, are preferably light in weight, have high impact strength, and maintain their color throughout the life of the automotive vehicle. Many plastic formulations suffer from structural warping due to heat build-up from long term exposure to sunlight.

Complex inorganic color pigments (“CICP”) have been incorporated into vinyl siding, particularly white vinyl siding, in order to decrease the heat build-up by increasing the IR reflectance properties of the siding. U.S. Pat. No. 6,454,848 B2 discloses the use of CICPs in building materials, such as, siding and roofing materials. A summary of many types of inorganic pigments and some of their applications can be found in the Kirk-Othmer Encyclopedia of Chemical Technology, Fourth Edition, Volume 18.

Decreasing the heat build-up of a plastic composition can also have the effect of decreasing the expansion demonstrated by a part made from the plastic composition. The decrease in expansion upon heating, particularly due to exposure to IR radiation, can allow for smaller gaps between adjacent plastic parts on automotive vehicles.

There is a desire in the manufacture of automotive vehicles, especially cars, to provide materials with improved properties and longevity. Another key consideration for automobile manufacturers is the overall weight of the vehicle and its effect on fuel consumption. The present teachings provide a means to improve material longevity and performance, and reduce the overall weight of the vehicle.

### SUMMARY

The present teachings satisfy the need for lightweight plastic automotive vehicle parts with improved resistance to heat build-up due to exposure to IR radiation.

The teachings of the present disclosure include the unpainted plastic automotive part including an infrared reflective pigment and a thermoplastic component. The unpainted plastic automotive part can reflect at least about 60% of at least one wavelength in the spectrum between about 750 nm and about 2500 nm wavelength. The unpainted plastic automotive part can have a maximum heat build-up temperature of less than about 95 C., and also exhibit a tensile elongation of no less than about 200%.

A method of reducing the heat build-up of a plastic automotive vehicle part is also provided by the present disclosure. The method involves providing an infrared reflective pigment and a plastic composition, incorporating the infrared reflective pigment into the plastic composition at a concentration of less than about 5 weight percent, and forming the plastic composition into a plastic automotive vehicle part. The plastic automotive vehicle part can then be exposed to a radiation source of between about 750 nm and about 2500 nm wavelength. Upon such exposure, the plastic automotive vehicle part can exhibit a maximum heat build-up temperature of less than about 95 C., while reflecting at least about 60% of at least one wavelength in the spectrum between about 750 nm and about 2500 nm wavelength, and having a tensile elongation of no less than about 200%.

Additionally, provided by this disclosure is a plastic composition for use on an automotive vehicle including an infrared reflective pigment and a thermoplastic component. The plastic composition can increase the reflectance between about 750 nm and 2500 nm by about 300%, and provides a delta T of at least about 15 C. over a color matched plastic composition containing no infrared reflective pigment under the procedures set forth in the ASTM Standard D 4803-97 test method.

Also provided by the present teachings is a method of reducing the heat build-up of a plastic automotive vehicle part including providing an infrared reflective pigment, incorporating the infrared reflective pigment into a plastic composition, forming the plastic composition into a plastic automotive vehicle part, and then exposing the plastic automotive vehicle part to an infrared radiation source. The plastic automotive vehicle part can have increased reflectance of at least about 300% between about 750 nm and about 2500 nm wavelength over a color matched plastic automotive vehicle part containing no infrared reflective pigment, which can result in a reduction in the heat build-up of the plastic automotive vehicle part.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings which are included to provide a further understanding of the present teachings and are incorporated in and constitute a part of this specification, illustrate various embodiments of the present teachings and together with the detailed description serve to explain the principles of the present teachings. In the drawings:

FIG. 1 is a graph of percent reflectance versus wavelength for reference samples and samples of plastics according to the present teachings;

FIG. 2 are thermal images of two standard plastic compositions and two plastic compositions according to the present teachings as tested under ASTM D 4803-97 protocol, and

FIG. 3 is a graph of percent tensile elongation versus weight percent loading of infrared reflective pigment at various loading levels for plastic samples according to the present teachings.

### DETAILED DESCRIPTION

This disclosure is directed to an unpainted plastic automotive part including an infrared reflective pigment, and a thermoplastic component. The unpainted plastic automotive part can incorporate sufficient infrared reflective pigment so that it can reflect at least about 60% of at least one wavelength in the spectrum between about 750 nm and about 2500 nm wavelength, has a maximum heat build-up temperature of less than about 95 C., and has a tensile elongation of no less than about 200%.

The presently taught unpainted plastic automotive part can, in some embodiments, reflect at least about 70% of at least one wavelength in the spectrum between about 750 nm and about 2500 nm wavelength, and have a maximum heat build-up temperature of less than about 75 C.

The present teachings relate to a plastic composition for use on an automotive vehicle comprising an infrared reflective pigment, and a thermoplastic component. The plastic composition can increase reflectance by at least about 300% in the spectrum between about 750 nm and about 2500 nm wavelength, and provides a delta T of at least about 15 C. over a color matched plastic composition containing no infrared reflective pigment under the procedures set forth in the ASTM Standard D 4803-97 test method.

The plastic composition can be a highly ductile plastic composition. High ductility refers to plastic compositions that have a tensile elongation of at least about 200% as measured by the ASTM Standard D 638-03 test procedure.

As disclosed by the present teachings, the plastic composition can increase reflectance by at least about 300% in the spectrum between about 750 nm and about 2500 nm wavelength, preferably, the plastic composition increases reflectance by at least about 350% of the spectrum between about 750 nm and about 2500 nm wavelength over a color matched plastic automotive vehicle part containing no infrared reflective pigment.

The plastic composition can provide a delta T of at least about 20 C., preferably a delta T of at least about 25 C., over a color matched plastic composition containing no infrared reflective pigment under the procedures set forth in the ASTM Standard D 4803-97 test method. As used herein, “heat build-up” refers to the change in temperature of a material exposed to infrared radiation as set forth in the protocol of the ASTM Standard D 4803-97 test method.

The present plastic composition can be uncoated, more preferably, the plastic composition is unpainted. The plastic composition can also contain additional colorants or dyes to add color to the finished product. The plastic composition can also include other additives to provide desired properties to the finished product.

The plastic composition can contain less than about 5 weight percent of the infrared reflective pigment. Preferably, the plastic composition can contain less than about 2 weight percent of the infrared reflective pigment.

According to the present teachings, the plastic composition can be formed into at least one member selected from the group consisting of left and right front fenders, left and right rear fenders, left and right front body panels, left and right rear body panels, door panels, hood panels, roof panels, trunk panels, tailgate panels, appliques or garnish parts, grilles, handles, and other general exterior components.

In the plastic composition formulation, the infrared reflective pigment can be a complex inorganic color pigment. Suitable complex inorganic color pigments are discussed below.

The plastic composition can be formulated from a plastic including at least one member selected from the group consisting of polyethylene, polystyrene, polypropylene, polyisobutylene, polyvinyl acetate, polyacrylonitrile, polyacrylic acid, polyester, polyamide, polycarbonate, polyolefin, substituted polyolefin, thermoplastic polyolefin rubber, polycarbonate/acrylonitrile styrene acrylate, acrylonitrile ethylene styrene, polycarbonate/polyethylene terephthalate, acrylonitrile styrene acrylate, and copolymers thereof.

A method of reducing the heat build-up of a plastic automotive vehicle part is also taught by the present disclosure. The method includes providing an infrared reflective pigment and a plastic composition, incorporating the infrared reflective pigment into the plastic composition at a concentration of less than about 5 weight percent, forming the plastic composition into a plastic automotive vehicle part, and exposing the plastic automotive vehicle part to a radiation source of between about 750 nm and about 2500 nm wavelength. The plastic automotive vehicle part provided by this method can have a maximum heat build-up temperature of less than about 95 C., and can reflect at least about 60% of at least one wavelength in the spectrum between about 750 nm and about 2500 nm wavelength. The plastic automotive vehicle part can also have a tensile elongation of no less than about 200%.

The present method can provided plastic automotive vehicle parts having maximum heat build-up temperature of less than about 75 C., and also parts that reflect at least about 70% of at least one wavelength in the spectrum between about 750 nm and about 2500 nm wavelength

The present teachings further provide a method of reducing the heat build-up of a plastic automotive vehicle part can include providing an infrared reflective pigment, incorporating the infrared reflective pigment into a plastic composition, forming the plastic composition into a plastic automotive vehicle part, and then exposing the plastic automotive vehicle part to an infrared radiation source. The plastic automotive vehicle part can increase reflectance by at least about 300% in the spectrum between about 750 nm and about 2500 nm wavelength over a color matched plastic automotive vehicle part containing no infrared reflective pigment.

According to the present method, the plastic automotive vehicle part can increase reflectance by at least about 350% in the spectrum between about 750 nm and about 2500 nm wavelength, more preferably, the plastic automotive vehicle part can increase reflectance by at least about 400% of the spectrum between about 750 nm and about 2500 nm wavelength over a color matched plastic automotive vehicle part containing no infrared reflective pigment.

The present method can include having the infrared reflective pigment present in the plastic composition in an amount sufficient to provide a delta T of at least about 15 C., preferably a delta T of at least about 20 C., and even more preferably a delta T of at least about 25 C. over a color matched plastic automotive vehicle part containing no infrared reflective pigment under the procedures set forth in the ASTM Standard D 4803-97 test method.

The present method can provide a plastic automotive vehicle part which can be uncoated and/or unpainted. In order to reduce complexity of manufacturing and weight of the finished vehicle, the finished automotive vehicle part should not be coated with, for example, a clear coat or top coat.

The plastic composition utilized to make the plastic automotive vehicle part can contain less than about 5 weight percent of the infrared reflective pigment, preferably the plastic composition can contain less than about 2 weight percent of the infrared reflective pigment.

The present method can be utilized to make any number of plastic automotive vehicle parts which can include at least one member selected from the group consisting of left and right front fenders, left and right rear fenders, left and right front body panels, left and right rear body panels, door panels, hood panels, roof panels, trunk panels, tailgate panels, appliques or garnish parts, grilles, handles, and other general exterior components.

In the present method, the infrared reflective pigment can include a complex inorganic color pigment. Complex inorganic color pigments suitable for use in various embodiments of the present teachings are set forth, for example, in U.S. Pat. Nos. 6,036,763; 6,174,360 B1; 6,235,106 B1; 6,416,868 B1; 6,454,848 B2; and 6,579,356 B2. The CICPs useful in the present teachings will have the ability to reflect IR at desired levels when the CICP is incorporated into the plastic composition at no more than about 5 weight percentage, preferably at no more than about 2 weight percentage.

According to the present teachings, the improved IR reflection capability exhibited by the CICPs allows the pigments to produce a desired color in the visible range, and also reflect a significant portion of the IR radiation outside of the visible range. By reflecting the IR radiation the surfaces of objects containing the CICPs remain cooler under solar radiation than those objects without the IR reflective CICPs. The CICPs preferably reflect IR wavelengths between about 700 nm and about 2000 nm at higher rates than the visible wavelengths (400-700 nm). The IR wavelengths can be broken down into three arbitrary regions including near-IR (700-2,000 nm), mid-IR (2,000-4,000 nm), and far-IR (4,000-5,500 nm). The CICPs exhibit much less heat buildup and much higher infrared radiation reflectance in comparison to conventional non-IR reflective colorants that yield a similar color.

The IR reflective performance of a pigment is typically determined by the relative amount of reflectance provided in the solar infrared region of the spectrum (700 to 2,500 nm wavelength) compared to the visible region of the spectrum (400 to 700 nm wavelength.) Common black pigments such as carbon black have low reflectance in both regions. To obtain enhanced IR reflectance, CICPs can be used in the various embodiments of the present teachings.

The plastic composition can include at least one member selected from the group consisting of polyethylene, polystyrene, polypropylene, polyisobutylene, polyvinyl acetate, polyacrylonitrile, polyacrylic acid, polyester, polyamide, polycarbonate, polyolefin, substituted polyolefin, thermoplastic polyolefin rubber, polycarbonate/acrylonitrile styrene acrylate, acrylonitrile ethylene styrene, polycarbonate/polyethylene terephthalate, acrylonitrile styrene acrylate, and copolymers thereof

According to the present disclosure, the plastic composition can be a highly ductile composition suitable for use on the exterior of an automotive vehicle. The incorporation of a sufficient amount of an infrared reflective pigment to reduce the heat buildup should not adversely influence the ductility of the composition. The ductility of the plastic composition can be measured by, for instance, determining the elongation of the material under tension. A suitable method for determining the elongation under tension is the ASTM Standard D 638-03 tensile strength measurement test method. As used herein, “tensile elongation” refers to the elongation of a test piece as measured under the ASTM Standard D 638-03 test method. More information about all the ASTM Standards and test methods described herein can be obtained from ASTM International, 100 Barr Harbor Drive, PO Box C700, West Conshohocken, Pa., 19428-2959. Tests performed under ASTM Standards may also be performed under equivalent testing protocols, such as, for example, JIS Standards and other industry recognized protocols and practices known to those of skill in the art.

The ASTM Standard D 4803-97 test method describes a test method for predicting the heat buildup in polyvinyl chloride based building products. This test method can be utilized to evaluate compositions for the efficiency of the composition to reflect portions of the infrared spectrum and thereby reduce heat buildup in an article composed of the composition.

Color matched plastic compositions refers to plastic compositions that have similar or identical colors. The colors of different plastic compositions can be measured and compared by utilizing a spectrophotometer and in accordance with the procedures set forth in ASTM Standard E308 (1996), Standard Practice for Computing the Colors of Objects by Using the CIE System. As used herein, “color matched compositions” means compositions with similar L*a*b* measurements, that is, compositions with colors which differ by a ΔE of less than about 1.5, and preferably differ by a ΔE of less than about 1.

As set forth above, and according to the present teachings, regardless of the specific infrared reflective pigment, or mixtures thereof, utilized in the plastic composition there should be sufficient infrared reflective pigment(s) present in the plastic composition to:
1) increase reflectance by about 300% in the infrared spectrum incident on the composition between about 750 nm and about 2500 nm wavelength, preferably at least about 350%, and most preferably at least about 400% over a color matched plastic automotive vehicle part containing no infrared reflective pigment, and/or
2) reduce the heat buildup in the plastic composition due to its exposure to infrared radiation by at least about 15 C. when measured according to the test methods and procedures set forth in ASTM D 4803-97. The reduction in heat buildup, or delta T, is calculated with respect to a plastic composition that has been color matched to the test composition but does not include any infrared reflective pigments. Alternatively, and for instance, when a color matched composition is not available for comparison purposes, then the heat buildup in a plastic composition according to the present teachings should have a maximum temperature of less than about 105 C., less than about 95 C., less than about 85 C., or less than about 75 C. during the ASTM D 4803-97 test, and/or,
3) reduce the effective coefficient of expansion of a piece composed of the plastic composition by at least about 26%, preferably by at least about 35%, and most preferably by at least about 44%. The effective reduction in the coefficient of expansion is due to the lowered temperature of the material, and preferably should be sufficient to allow for a tighter fit, that is, less space, between adjoining parts on an automotive vehicle.

Vehicle parts can be preformed pieces that are assembled to produce the body of a vehicle. Examples of vehicle parts or body panels can include the hood, trunk lid, fenders, doors, roof panels, quarter panels, appliques or garnish parts, grilles, handles, and other general exterior components. Each of these body panels can be separate body panels that are then joined together, for example by, fitting and joining the panels together. The joining of the panels can be accomplished by several different methods including, for example, adhering, bolting, gluing, screwing and riveting. Some of the body panels can have both an outer skin and an inner panel. The inner panels of the body panels are typically reinforcements for the rear of the passenger section, the trunk, and the wheel housings.

As used herein, automotive vehicle refers to any vehicle which can move under its own power, for example and without limitation, cars, trucks, buses, motorcycles, tractors, all-terrain vehicles, self-propelled lawnmowers, riding lawnmowers, motor scooters and so forth.

All publications, articles, papers, patents, patent publications, and other references cited herein are hereby incorporated herein in their entireties for all purposes.

Although the foregoing description is directed to the preferred embodiments of the present teachings, it is noted that other variations and modifications will be apparent to those skilled in the art, and which may be made without departing from the spirit or scope of the present teachings.

The following examples are presented to provide a more complete understanding of the present teachings. The specific techniques, conditions, materials, and reported data set forth to illustrate the principles of the present teachings are exemplary and should not be construed as limiting the scope of the present teachings.

### EXAMPLES

### Example 1

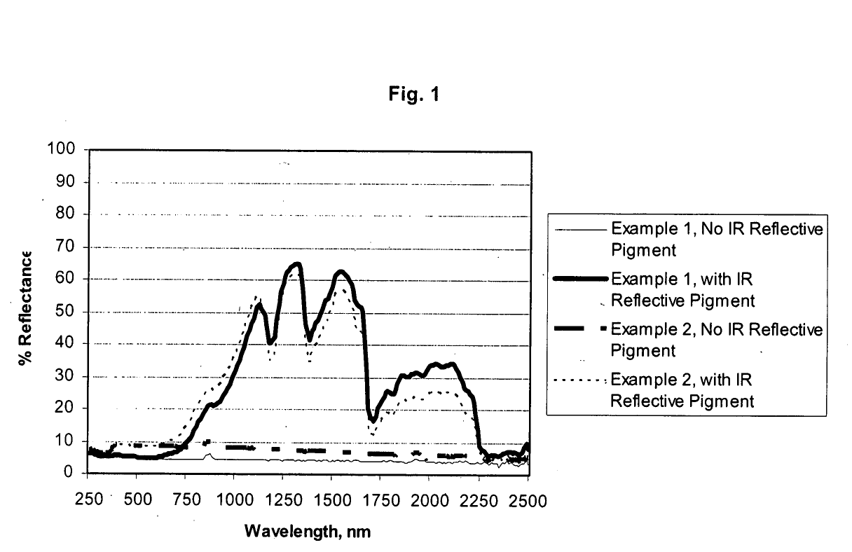

Two polypropylene compositions were prepared by standard techniques. Both compositions were nominally black in color; one of the compositions utilized standard non-IR reflective colorants, while the other composition utilized an IR reflective CICP colorant. The IR reflective CICP colorant was added to the polypropylene at less than about 2 wt. %. The samples were measured for color match, and then tested for IR reflectance using a Devices and Services Co. (Dallas, Tex.) Model SSR solar spectrum reflectometer. The IR reflectance results are presented in FIG. 1.

The results demonstrate the increase in IR reflectance achieved by incorporating IR reflective CICP into the polypropylene composition.

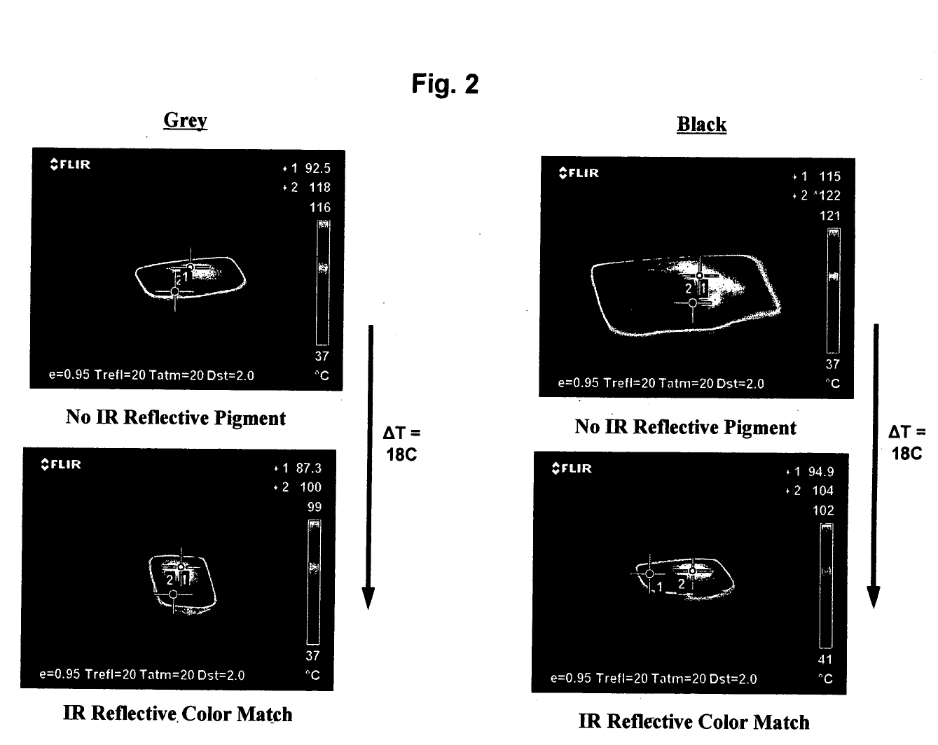

Sheets of each composition were then prepared and measured for their ability to resist heat build-up upon exposure to an IR heat source as further detailed in ASTM D 4803-97 Test Method. As measured by a thermal imaging camera, the sample sheet containing the IR reflective CICP had a maximum temperature 18 C. lower than the sample sheet containing a standard non-IR reflective colorant; 100 C. for CICP-containing sample versus 118 C. The results are presented in FIG. 2.

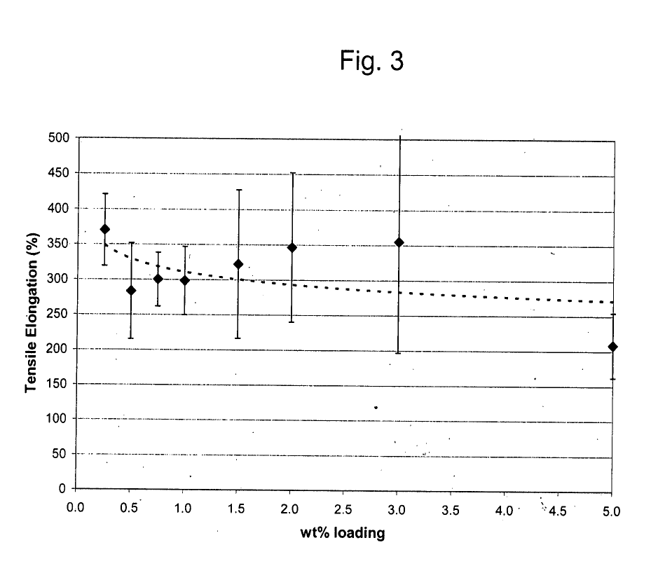

Samples were prepared with the same base materials including varying levels of CICP, from 0.25% to 5%. These samples were tested for tensile elongation. There was no reduction in elongation at up to 3 wt. % loading level, and no appreciable reduction in elongation at up to 5 wt. % loading level. The results are presented in FIG. 3.

### Example 2

Two polypropylene compositions were prepared by standard techniques. Both compositions were nominally gray in color; one of the compositions utilized standard non-IR reflective colorants, while the other composition utilized an IR reflective CICP colorant. The IR reflective CICP colorant was added to the polypropylene at less than about 2 wt. %. The samples were measured for color match, and then tested for IR reflectance using a Devices and Services Co. Model SSR solar spectrum reflectometer. The IR reflectance results are presented in FIG. 1.

The results demonstrate the increase in IR reflectance achieved by incorporating IR reflective CICP into the polypropylene composition.

Sheets of each composition were then prepared and measured for their ability to resist heat build-up upon exposure to an IR heat source as further detailed in ASTM D 4803-97 Test Method. As measured by a thermal imaging camera, the sample sheet containing the IR reflective CICP had a maximum temperature 18 C. lower than the sample sheet containing a standard non-IR reflective colorant; 104 C. for CICP-containing sample versus 122 C. The results are presented in FIG. 2.

The foregoing detailed description of the various embodiments of the present teachings has been provided for the purposes of illustration and description. It is not intended to be exhaustive or to limit the present teachings to the precise embodiments disclosed. Many modifications and variations will be apparent to practitioners skilled in this art. The embodiments were chosen and described in order to best explain the principles of the present teachings and their practical application, thereby enabling others skilled in the art to understand the present teachings for various embodiments and with various modifications as are suited to the particular use contemplated. It is intended that the scope of the present teachings be defined by the following claims and their equivalents

What we claim is:

1. An unpainted plastic automotive part comprising
an infrared reflective pigment, and
a thermoplastic component;
wherein the infrared reflective pigment is present in a concentration sufficient to cause the unpainted plastic automotive part to reflect at least about 60% of at least one wavelength in the spectrum between about 750 nm and about 2500 nm wavelength,
to have a maximum heat build-up temperature of less than about 95 C., and
to have a tensile elongation of no less than about 200%.

2. The unpainted plastic automotive part according to claim 1, wherein the unpainted plastic automotive part reflects at least about 70% of at least one wavelength in the spectrum between about 750 nm and about 2500 nm wavelength.

3. The unpainted plastic automotive part according to claim 1, wherein the unpainted plastic automotive part provides a delta T of about 20 C. over a color matched plastic composition containing no infrared reflective pigment under the procedures set forth in the ASTM Standard D 4803-97 test method.

4. The unpainted plastic automotive part according to claim 1, wherein the unpainted plastic automotive part is uncoated.

5. The unpainted plastic automotive part according to claim 1, wherein the unpainted plastic automotive part contains less than about 5 weight percent of the infrared reflective pigment.

6. The unpainted plastic automotive part according to claim 1, wherein the unpainted plastic automotive part contains less than about 2 weight percent of the infrared reflective pigment.

7. The unpainted plastic automotive part according to claim 1, wherein the unpainted plastic automotive part is at least one member selected from the group consisting of left and right front fenders, left and right rear fenders, left and right front body panels, left and right rear body panels, door panels, hood panels, roof panels, trunk panels, tailgate panels, appliques or garnish parts, grilles, handles, and other general exterior components.

8. The unpainted plastic automotive part according to claim 1, wherein the infrared reflective pigment comprises a complex inorganic color pigment.

9. The unpainted plastic automotive part according to claim 1, wherein the thermoplastic component comprises at least one member selected from the group consisting of polyethylene, polystyrene, polypropylene, polyisobutylene, polyvinyl acetate, polyacrylonitrile, polyacrylic acid, polyester, polyamide, polycarbonate, polyolefin, substituted polyolefin, thermoplastic polyolefin rubber, polycarbonate/acrylonitrile styrene acrylate, acrylonitrile ethylene styrene, polycarbonate/polyethylene terephthalate, acrylonitrile styrene acrylate, and copolymers thereof.

10. A method of reducing the heat build-up of a plastic automotive vehicle part comprising
providing an infrared reflective pigment and a plastic composition;
incorporating the infrared reflective pigment into the plastic composition at a concentration of less than about 5 weight percent;
forming the plastic composition into a plastic automotive vehicle part; and
exposing the plastic automotive vehicle part to a radiation source of between about 750 nm and about 2500 nm wavelength,
wherein the plastic automotive vehicle part has a maximum heat build-up temperature of less than about 95 C.,
reflects at least about 60% of at least one wavelength in the spectrum between about 750 nm and about 2500 nm wavelength, and
has a tensile elongation of no less than about 200%.

11. The method according to claim 10, wherein the plastic automotive vehicle part reflects at least about 70% of at least one wavelength in the spectrum between about 750 nm and about 2500 nm wavelength.

12. The method according to claim 10, wherein the infrared reflective pigment is present in the plastic composition in an amount sufficient to provide a maximum heat build-up temperature of less than about 75 C.

13. The method according to claim 10, wherein the plastic automotive vehicle part is uncoated.

14. The method according to claim 10, wherein the infrared reflective pigment is incorporated into the plastic composition at a concentration of less than about 2 weight percent.

15. The method according to claim 10, wherein the plastic automotive vehicle part comprises at least one member selected from the group consisting of left and right front fenders, left and right rear fenders, left and right front body panels, left and right rear body panels, door panels, hood panels, roof panels, trunk panels, tailgate panels, appliques or garnish parts, grilles, handles, and other general exterior components.

16. The method according to claim 10, wherein the infrared reflective pigment comprises a complex inorganic color pigment.

17. The method according to claim 10, wherein the plastic composition comprises at least one member selected from the group consisting of polyethylene, polystyrene, polypropylene, polyisobutylene, polyvinyl acetate, polyacrylonitrile, polyacrylic acid, polyester, polyamide, polycarbonate, polyolefin, substituted polyolefin, thermoplastic polyolefin rubber, polycarbonate/acrylonitrile styrene acrylate, acrylonitrile ethylene styrene, polycarbonate/polyethylene terephthalate, acrylonitrile styrene acrylate, and copolymers thereof.

18. A plastic composition for use on an automotive vehicle comprising
an infrared reflective pigment, and
a thermoplastic component; and
wherein the infrared reflective pigment is present in a concentration sufficient to cause the plastic composition to have an increased reflectance of about 300% in the spectrum between about 750 nm and about 2500 nm wavelength over a color matched plastic composition containing no infrared reflective pigment, and to provide a delta T of about 15 C. over a color matched plastic composition containing no infrared reflective pigment under the procedures set forth in the ASTM Standard D 4803-97 test method.

19. The plastic composition according to claim 18, wherein the plastic composition has an increased reflection of about 350% in the spectrum between about 750 nm and about 2500 nm wavelength over a color matched plastic automotive vehicle part containing no infrared reflective pigment.

20. The plastic composition according to claim 18, wherein the plastic composition provides a delta T of about 20 C. over a color matched plastic composition containing no infrared reflective pigment under the procedures set forth in the ASTM Standard D 4803-97 test method.

21. The plastic composition according to claim 18, wherein the plastic composition is uncoated.

22. The plastic composition according to claim 18, wherein the plastic composition contains less than about 5 weight percent of the infrared reflective pigment.

23. The plastic composition according to claim 18, wherein the plastic composition contains less than about 2 weight percent of the infrared reflective pigment.

24. The plastic composition according to claim 18, wherein the plastic composition is formed into at least one member selected from the group consisting of left and right front fenders, left and right rear fenders, left and right front body panels, left and right rear body panels, door panels, hood panels, roof panels, trunk panels, tailgate panels, appliques or garnish parts, grilles, handles, and other general exterior components.

25. The plastic composition according to claim 18, wherein the infrared reflective pigment comprises a complex inorganic color pigment.

26. The plastic composition according to claim 18, wherein the plastic composition comprises at least one member selected from the group consisting of polyethylene, polystyrene, polypropylene, polyisobutylene, polyvinyl acetate, polyacrylonitrile, polyacrylic acid, polyester, polyamide, polycarbonate, polyolefin, substituted polyolefin, thermoplastic polyolefin rubber, polycarbonate/acrylonitrile styrene acrylate, acrylonitrile ethylene styrene, polycarbonate/polyethylene terephthalate, acrylonitrile styrene acrylate, and copolymers thereof.
